(19) United States
(12) Patent Application Publication
(10) Pub. No.: US 2015/0242885 A1
(43) Pub. Date: Aug. 27, 2015

(54) INVITATIONAL CONTENT ATTRIBUTION

(71) Applicant: Apple Inc., Cupertino, CA (US)

(72) Inventors: Thomas Alsina, Mountain View, CA (US); David T. Wilson, Campbell, CA (US); Kenley Sun, Cupertino, CA (US)

(73) Assignee: Apple Inc., Cupertino, CA (US)

(21) Appl. No.: 14/186,301

(22) Filed: Feb. 21, 2014

(51) Int. Cl. G06Q 30/02

(52) U.S. Cl. CPC G06Q 30/0246; G06Q 30/0244

(57) ABSTRACT

Systems, methods, and computer-readable storage media for invitational content attribution. The system tracks a user's conversion of an item of invitational content and correlates the user's conversion with a previously-served impression based on a token of information associated with the previously-served impression, wherein the token of information includes a unique identifier associated with the previously-served impression and a timestamp corresponding to a time of impression. The system then reports the previously-served impression as being correlated to the user's conversion.

### TECHNICAL FIELD

The present technology pertains to invitational content, and more specifically pertains to attribution of conversions to particular invitational content items and providers.

### BACKGROUND

Digital advertising is widely used by advertisers to market their products via network devices, such as mobile phones and tablet computers. Given the widespread availability of these devices as well as network connectivity, digital advertising can be an extremely effective way for advertisers to reach a wide mass of potential customers and induce numerous users to purchase their products. By targeting users with effective digital advertisements, advertisers can yield large financial returns from their digital advertisements. Not surprisingly, many advertisers continuously measure the performance of their advertisements to understand how, if necessary, they can optimize their advertisements for a better performance.

Current solutions often attempt to obtain information about a user or segment to modify an advertisement campaign based on such information about the user or segment. This allows the advertisers to better target their advertisements and modify the presentation parameters for better performance. In addition, current solutions frequently attempt to obtain performance metrics of a campaign, to help advertisers track the performance of their advertising campaigns. However, the performance metrics calculated by current systems are typically general to the campaign as a whole. For example, the performance metrics often capture statistics of a campaign by calculating the number of impressions served relative to the number of conversions obtained in the campaign. Thus, disadvantageously, the performance metrics calculated in current systems fail to depict more granular performance statistics, such as specific performance or results of each impression and particular histories of each conversion.

For example, while current solutions can provide an advertiser with statistics relating to the ratio of successful impressions, they are unable to identify the specific impressions that led to, or resulted in, a conversion, or which content providers served those impressions that resulted in conversions. In fact, with the current performance metrics, individual advertisers and content providers are incapable of attributing a conversion to a specific impression by ascertaining which of a number of impressions actually triggered or yielded the conversion. Yet advertisers can greatly benefit from an understanding of this information and can significantly optimize their campaigns based on individual statistics.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can be used to track impressions leading to a conversion event, such as a download or purchase. The specific impressions or presentations of content responsible for triggering a conversion event can be identified and reported to allow content providers, developers, or advertisers determine which impressions or presentations have yielded conversions and which have not. The applications serving the impressions or content (e.g., the content providers) can also be determined and reported to allow providers, developers, or advertisers understand which applications have yield conversions (and how many), and which have not. This way, an advertiser, for example, can determine which applications and impressions have been successful and which have not. These statistics can also help better target content presentations or modify which applications are used to present content and how the content is presented to the user.

Disclosed are systems, methods, and non-transitory computer-readable storage media for invitational content attribution. A system first detects a conversion event associated with a campaign of invitational content. The conversion event can be, for example, an action taken by a user to purchase or download an item, initiate a subscription, submit a registration, etc. In some cases, the campaign of invitational content can be an advertising or subscription campaign. Here, the conversion event associated with the campaign of invitational content can be a purchase of an item advertised via an advertising campaign, for example.

The system then generates conversion data for the conversion event. Here, the conversion data can include a timestamp, a conversion description or identifier, user information, campaign information, a history of impressions, a previous impression, triggering details, and so forth. In some aspects, the system generates the conversion data and associates it with the conversion event. For example, the system can generate a record describing the conversion event and associate it with a timestamp or any other relevant metadata. The conversion data can thus include an association of conversion details or metadata and information about the conversion event or otherwise associated with the conversion event. The system can store the conversion data, including any associations made with information relating to the conversion event, in a local or remote store, database, server, etc. For example, the system can maintain a database of conversion events and store any conversion data generated in the database of conversion events.

Next, the system correlates the conversion event with a previously-served impression based on the conversion data and a token of information associated with the previously-served impression, wherein the token of information includes a unique identifier associated with the previously-served impression and a timestamp corresponding to a time of impression. The system can compare the timestamp of the conversion event with the timestamp of the previously-served impression and any other timestamps associated with other impressions, in order to identify the specific impression that should be correlated to the conversion event. Each impression in a campaign can include the token previously described. Thus, based on the unique identifier in each impression's token, the system can identify specific impressions corresponding to timestamps that the system has compared with the timestamp of the conversion event to make a correlation.

The system can correlate the conversion event with the previously-served impression as part of identifying which impression triggered the conversion event, is responsible for the conversion event, or should receive credit or attribution for the conversion event. Moreover, in some aspects, the impression correlated with the conversion event is the last impression leading to the conversion event. For example, if an item of invitational content has several impressions and is associated with a conversion event, the impression correlated to the conversion event can be the last of the several impressions prior to the correlation event. To this end, the system can identify such last impression by comparing the timestamps of impressions and conversion events, as previously described. Further, in some embodiments, the previously-served impression can refer to the last impression before the conversion event.

Once the system has correlated the previously-served impression with the conversion event, it can report the previously-served impression as being correlated to the conversion event. The system can report the correlation to a server, a content provider, an advertiser, a developer, a user, a statistics collection device, etc. When reporting the correlation, the system can attribute the conversion event to the previously-served impression. Thus, the system can credit the previously-served impression, and the application having served the invitational content associated with the previously-served impression, for the conversion event, as triggering or obtaining the conversion event. This way, an advertiser, for example, can which specific impressions have resulted in a conversion event, and identify which applications or publishers have yielded conversions. The advertiser can also compare conversion results between applications, publishers, and impressions to determine which have been successful and which have not.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates an exemplary schematic system 200 for content attribution;

FIG. 3 illustrates an illustrates a schematic diagram of an exemplary configuration for content attribution;

FIG. 4 illustrates an exemplary token associated with a content item;

FIG. 5 illustrates an exemplary attribution mapping;

FIG. 6 illustrates an exemplary attribution table;

FIG. 7 illustrates an exemplary method embodiment; and

FIG. 8A and FIG. 8B illustrate exemplary system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

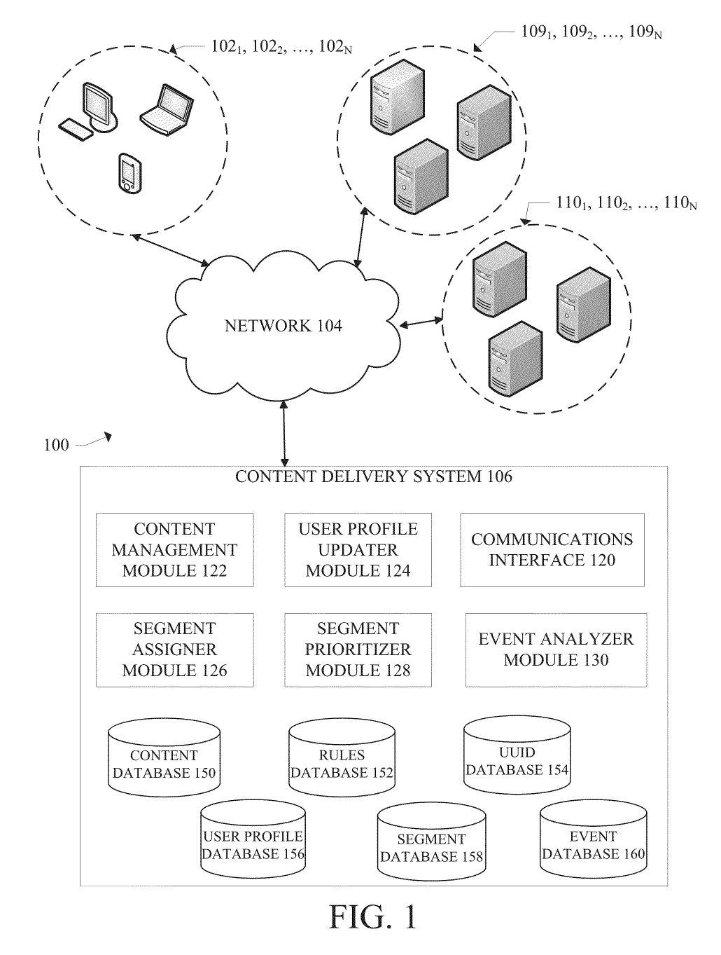

The disclosed technology addresses the need in the art for accurate and efficient attribution of invitational content. Disclosed are systems, methods, and non-transitory computer-readable storage media for attributing invitational content. A brief introductory description of an exemplary configuration of devices and a network is disclosed herein. A detailed description of invitational content attribution, and exemplary variations will then follow. These variations shall be described herein as the various embodiments are set forth. The disclosure now turns to FIG. 1.

An exemplary system configuration 100 is illustrated in FIG. 1, wherein electronic devices communicate via a network for purposes of exchanging content and other data. The system can be configured for use on a wide area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, invitational content can be delivered to user terminals 102₁, 102₂, . . . , 102ₙ (collectively “102”) connected to a network 104 by direct and/or indirect communications with a content delivery system 106. User terminals 102 can be any network enabled client devices, such as desktop computers; mobile computers; handheld communications devices, e.g. mobile phones, smart phones, tablets; smart televisions; set-top boxes; and/or any other network enabled computing devices. Furthermore, content delivery system 106 can concurrently accept connections from and interact with multiple user terminals 102.

The content delivery system 106 can receive a request for electronic content, such as a web page, an application, a media item, etc., from one of user terminals 102. Thereafter, the content delivery system 106 can assemble a content package and transmit the assembled content page to the requesting one of user terminals 102. To facilitate communications with the user terminals 102 and/or any other device or component, the content delivery system 106 can include a communications interface 120.

The content delivery system 106 can include a content management module 122 to facilitate the generation of an assembled content package. Specifically, the content management module 122 can combine content from one or more primary content providers 109₁, 109₂, . . . , 109ₙ (collectively “109”) and content from one or more secondary content providers 110₁, 110₂, . . . 110ₙ (collectively “110”) to generate the assembled content package for the user terminals 102. For example, in the case of a web page being delivered to a requesting one of user terminals 102, the content management module 122 can assemble a content package by requesting the data for the web page from one of the primary content providers 109 maintaining the web page. For the invitational content on the web page provided by the secondary content providers 110, the content management module 122 can request the appropriate data according to the arrangement between the primary and secondary content providers 109 and 110. Additionally, the content management module 122 can create content packages that contain content from a single content provider. That is, a content package can contain only primary content or a content package can contain only secondary content. However, the content package is not limited to the content from content providers 109 and 110. Rather, the content package can include other data generated at the content delivery system 106. In some embodiments, the content delivery system 106 can preselect the content package before a request is received.

An assembled content package can include text, graphics, audio, video, executable code, or any combination thereof. Further, an assembled content package can include invitational content designed to inform or elicit a pre-defined response from the user. In some embodiments, the invitational content can be associated with a product or can directly or indirectly advertise a product. For example, the assembled content package can include one or more types of advertisements from one or more advertisers.

Additionally, the invitational content can be active invitational content. That is, invitational content that is designed to primarily elicit a pre-defined response from a user. For example, active invitational content can include one or more types of advertisements configured to be clicked upon, solicit information, or be converted by the user into a further action, such as a purchase or a download of the advertised item. However, invitational content can also be passive invitational content. That is invitational content that is designed to primarily inform the user, such as a video. In some cases, passive invitational content can include information that can lead or direct users to other invitational content including active invitational content.

Furthermore, the invitational content can be dynamic invitational content. That is invitational content that varies over time or that varies based on user interaction. For example, dynamic invitational content can include an interactive game. However, the various embodiments are not limited in this regard and the invitational content can include static invitational content that neither varies over time nor with user interaction. In the various embodiments, invitational content in a content package can be static or dynamic and active or passive. A content package can include a combination of various types of invitational content in a single content package.

In some cases, a content package can replace or update invitational content in a content package already delivered to a user terminal. For example, a first content package can include an app that can be installed on the user terminal 102ᵢ. A subsequent content package can include one or more items of invitational content that can be presented to a user of the user terminal 102ᵢ while the user interacts with the app.

Although primary and secondary providers 109 and 110 are presented herein as separate entities, this is for illustrative purposes only. In some cases, the primary and the secondary content providers 109 and 110 can be the same entity. Thus, a single entity can provide both the primary and the secondary content.

The content management module 122 can be configured to request that content be sent directly from content providers 109 and 110. Alternatively, a cached arrangement can also be used to improve performance of the content delivery system 106 and improve overall user experience. That is, the content delivery system 106 can include a content database 150 for locally storing/caching content maintained by content providers 109 and 110. The data in the content database 150 can be refreshed or updated on a regular basis to ensure that the content in the database 150 is up to date at the time of a request from a user terminal 102ᵢ. However, in some cases, the content management module 122 can be configured to retrieve content directly from content providers 109 and 110 if the metadata associated with the data in the content database 150 appears to be outdated or corrupted.

In some configurations, the content database 150 can maintain content items for presentation at the user terminals 102. The content database 150 can also maintain content associations with specific places, such as locales. Moreover, the content database 150 can maintain database corresponding to specific items of content. The metadata can specify unique identifiers, location information, association information, ranking information, etc. The content database 150 can also maintain lists of content items filtered or selected based on specific rules or criteria. For example, the content database 150 can maintain lists of content items that are relevant to specific geographic areas, demographics, segments, etc.

As described above, content maintained by the content providers 109 and 110 can be combined according to a predefined arrangement between the two content providers, which can be embodied as a set of rules. In an arrangement where the content delivery system 106 assembles the content package from multiple content providers, the assembly rules can be stored in a rules database 152 in the content delivery system 106. The content management module 122 can be configured to assemble the content package for user terminals 102 based on these rules. The rules can specify how to select content from secondary content providers 110 and primary content providers 109 in response to a request from one of user terminals 102. For example, in the case of a web page maintained by one of primary content providers 109 and including invitational content, the rules database 152 can specify rules for selecting one of the secondary providers 110. The rules can also specify how to select specific content from the selected one of secondary providers 110 to be combined with the content provided by one of primary providers 109. In some cases, an item of primary content, such as an app or other media object, can have one or more associated attributes. For example, an app can have one or more associated genre attributes, e.g. travel, sports, education, etc. A rule can be based at least in part on the primary content attributes. Once assembled, the assembled content package can be sent to a requesting one of user terminals 102.

Additionally, rules for combining primary and secondary content can be based on user characteristics known about the user. In particular, in some cases, invitational content can be selected based on the characteristics of the requesting user(s). As used herein, the term “user characteristics” refers to the characteristics of a particular user associated with one or more of user terminals 102. User characteristics can include channel characteristics, demographic characteristics, behavioral characteristics, and spatial-temporal characteristics. Channel characteristics can define the specific delivery channel being used to deliver a content package to a user. For example, channel characteristics can include a type of electronic content, a type of device or user terminal, a carrier or network provider, or any other characteristic that defines a specific delivery channel for the content package. Spatial-temporal characteristics can define a location, a location zone, a date, a time, or any other characteristic that defines a geographic location and/or a time for delivery of the content package. Demographic characteristics can define characteristics of the users targeted by the content or associated with the content. For example, demographic characteristics can include age, income, gender, occupation, or any other user characteristics. Behavioral characteristics can define user behaviors for one or more different types of content, separately or in combination with any other user characteristics. That is, different behavioral characteristics may be associated with different channel, demographic, or spatial-temporal characteristics. User characteristics can also include characteristics descriptive of a user's state of mind including characteristics indicative of how likely a user is to click on or convert an item of invitational content if it were displayed to the user. User characteristics can be learned directly or derived indirectly from a variety of sources. In some embodiments, the user characteristic values can be collected from one or more databases. For example, if the user is registered with an online media service, such as the ITUNES store maintained by Apple Inc. of Cupertino, Calif., the collected data could include the user's registration information. Such data can provide values for declared user characteristics. Furthermore, the content delivery system 106 can be configured to learn of or derive user characteristics from any number of other information sources. For example, in some configurations, the content delivery system 106 can derive or infer one or more user characteristic values from user characteristic values already known about the user.

In some embodiments, the interactive content can be associated with one or more targeted segments. A targeted segment can be viewed as defining a space or region in k-dimensional space, where each of the k dimensions is associated with one of a plurality of user characteristics. In the various embodiments, the k dimensions can include both orthogonal and non-orthogonal dimensions. That is, some of the k dimensions can overlap or can be related in some aspect.

In the various embodiments, the content delivery system 106 can also include a unique user identifier (UUID) database 154 that can be used for managing sessions with the various user terminal devices 102. The UUID database 154 can be used with a variety of session management techniques. For example, the content delivery system 106 can implement an HTTP cookie or any other conventional session management method (e.g., IP address tracking, URL query strings, hidden form fields, window name tracking, authentication methods, and local shared objects) for user terminals 102 connected to content delivery system 106 via a substantially persistent network session. However, other methods can be used as well. For example, in the case of handheld communications devices, e.g. mobile phones, smart phones, tablets, or other types of user terminals connecting using multiple or non-persistent network sessions, multiple requests for content from such devices may be assigned to a same entry in the UUID database 154. The content delivery system 106 can analyze the attributes of requesting devices to determine whether such requests can be attributed to the same device. Such attributes can include device or group-specific attributes.

In some embodiments, the content delivery system 106 can include a user-profile database 156. The user-profile database 156 can, at least in part, be constructed based on declared user characteristics related to one or more users. In some cases, the user-profile database may contain inferred or derived user characteristic values. The user-profile database 156 can be updated using a user-profile-updater module 124. In some embodiments, the user-profile-updater module 124 can be configured to add additional profile data, update profile data, fill in missing profile data, or infer user characteristic values from declared data.

The user-profile-updater module 124 can also be configured to maintain the user profile database 156 to include only more recently acquired data or to re-derive any inferred characteristics in order to ensure that the user profile is an accurate reflection of the current state of the user (location, state of mind, behaviors, demographics, etc. can change rapidly). For example, the user-profile-updater module 124 can be configured to maintain the user profile database 156 to include only data from the last two to three months. However, the user-profile-updater module 124 can be configured to adjust the data in the user profile database 156 to cover any span of time. In some instances the user-profile-updater module 124 can update the profile database 156 in real-time. Alternatively, the user-profile-updater module 124 can be configured to set an expiration period on a subset of the data in the user profile database 156. For example, a policy can specify that user declared data is maintained as long as the user account is active, but user characteristic values based on location information expire after a specified period of time. In some cases, a user can set the expiration period. In some instances, the user-profile-updater module 124 can update the user profile database 156 at least every week, or every day. In some cases, the content delivery system 106 can receive a direct request to update one or more user profiles. The update request can come directly from the user's device or any other device capable of communicating with the content delivery system 106, such as other content delivery networks or websites. In some cases, the content delivery system 106 can receive an indirect request to update one or more user profiles. An indirect request can be the result of receiving new user characteristic values. An update request can occur at any time.

In some embodiments, the content delivery system 106 can include a segment database 158 that is used to aid in selecting invitational content to target to users. The segment database 158 can store defined segments and associations between the segments and users and/or invitational content that should be targeted to users associated with the segments. As described above, a targeted segment can be defined based on one or more user characteristics or derivatives thereof and can be associated with one or more items of invitational content. Additionally, a targeted segment can be associated with one or more users. In some embodiments, by associating a targeted segment with both a user and an item of invitational content, the delivery system can match invitational content with users. In some embodiments, the content delivery system 106 can update the segment database 158 to add newly defined targeted segments or to delete targeted segments.

In some cases a targeted segment can be as simple as a single user characteristic identifier and a single user characteristic value. For example, the common demographic identifiers of gender, age, occupation, or income can each be used in defining corresponding targeted segments. A characteristic value can also be assigned to the identifier. For example, the values of male, 19, and student can be assigned to the user characteristics of gender, age, and occupation, respectively. However, more complex targeted segments can also be defined that consist of one or more identifiers with one or more values associated with each identifier. For example, a targeted segment can be defined to target a user with the following characteristics: gender, male; age, 19-24; location, Northern California or New York City. Additional exemplary segments are described throughout this disclosure. Furthermore, targeted segments can correspond to one or more segments that content providers are likely to easily understand and thus can quickly identify as being relevant to their content. Additionally, in some embodiments, content providers 109 and 110 can define a custom targeted segment.

In some embodiments, the content delivery system 106 can provide a segment assigner module 126. The segment assigner module 126 can apply a set of user characteristics associated with a user (including segments to which a user has been previously assigned) to assign the user to one or more targeted segments. The assigner module 126 can obtain the set of user characteristic values from the user profile database 154 and/or from the user's activities during the current session. The segment assigner module 126 can assign a user to one or more defined targeted segments in the segment database 158, or alternatively, a user can be assigned to a custom targeted segment defined to meet specific goals of a content provider.

Based on the assigned segments, the user profile database 156 can be updated to reflect the segment assignments. Additionally, the content delivery system 106 can use the segment assignments to select targeted content. In some cases, the user profile data in the user profile database 156 can change over time so the segment assigner module 126 can be configured to periodically update the segment assignments in the user profile database 156. The segment assignment update can be triggered at specified intervals, upon detection of a change in the user profile database 156, and/or upon detection of a specified activity in the content delivery system 106.

In some embodiments, the content delivery system 106 can provide a prioritizer module 128. The prioritizer module 128 can perform a variety of prioritizing tasks based on the configuration of the content delivery system 106. In some configurations, the prioritizer module 128 can prioritize the targeted segments assigned to a user. The prioritization can be influenced by a number of factors, which can include the user's context, a content provider's campaign goals, and/or the content that is currently available for display to the user. A request to prioritize the targeted segments can be explicit or implicit and can be made by any component of the system 100. For example, a secondary content provider 110 can explicitly request that the content delivery system 106 prioritize the targeted segments or the request can be implicit as part of a request for a content package. The resulting prioritized list can be provided, for example, to the content management module 122, which can then use the information to assemble and deliver a content package. Additionally, the prioritized list can be stored, for example in the user profile, for later use.

The event analyzer module 130 can be configured to collect, store, generate, detect, receive, and analyze event data. In some configurations, the event data can include conversion event data, presentation data, impression data, and so forth. For example, the event analyzer module 130 can collect impressions or invitational content presentations at user terminals 102 and conversion events, such as purchases, downloads, subscriptions, and registrations. Each of the data items collected can be associated with a particular campaign of content. Moreover, each of the data items can include a respective timestamp. For example, the event analyzer module 130 can detect conversion events and associate the detected conversion events with respective timestamps corresponding to times when the conversion events took place. Similarly, the event analyzer module 130 can detect an impression and associate the impression with a timestamp indicating when the impression took place.

The event analyzer module 130 can additionally collect or generate further information associated with an event, such as a conversion event or an impression. Moreover, the event analyzer module 130 can analyze any available information for events to associate one or more events with each other. For example, the event analyzer module 130 can analyze information associated with a conversion event to associate the conversion event with an impression event. In some cases, the event analyzer module 130 can generate record or reports correlating different events based on associated information, such as timestamps, for example. The event analyzer module 130 can also identify specific types of events, such as impressions, and credit those events with another correlated or corresponding event, such as a conversion event. In addition, the event analyzer module 130 can attribute specific events such as conversion events to an application or content item associated with a correlated or corresponding event, such as an impression or a content presentation event. Additional details for correlating, crediting, or associating events and attributing applications is further described below.

The content delivery system 106 can also include an event database 160 to store event data, such as data generated, collected, or analyzed by the event analyzer module 130. For example, the event database 160 can store conversion events, impressions, or content presentations associated with a campaign of content. In some cases, the event database 160 can store details relating to associations, correlations, or attributions determined or generated by the event analyzer module 130. Moreover, the event database 160 can store records, data, and information associated with campaigns of content and any associated event. Further, the event database 160 can store additional details associated with an event, such as a timestamp, statistics, a context, a description, an identifier, an association, a link, a content item, a token, metadata, etc.

While the content delivery system 106 is presented with specific components, it should be understood by one skilled in the art, that the architectural configuration of system 106 is simply one possible configuration and that other configurations with more or less components are also possible.

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

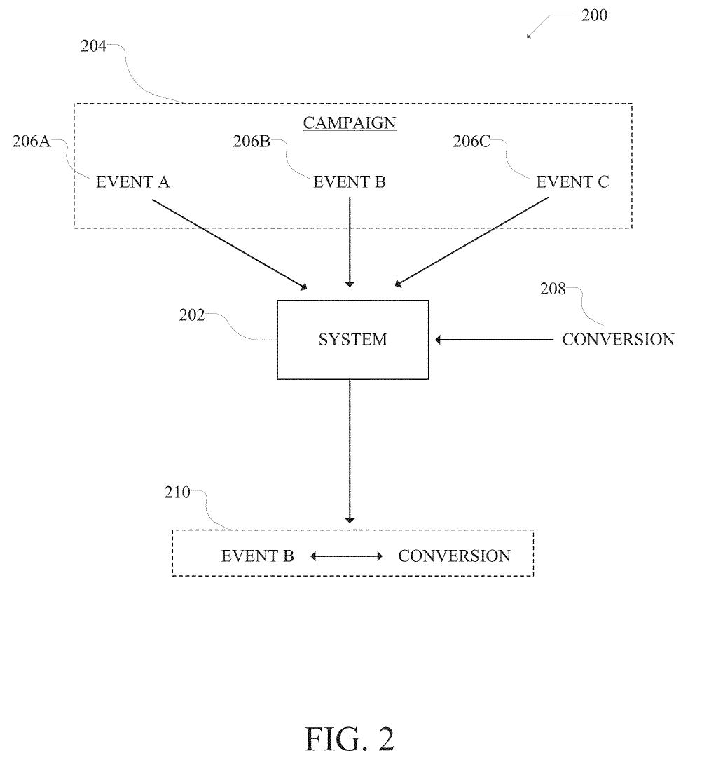

The disclosure now turns to FIG. 2, which illustrates an exemplary schematic system 200 for content attribution. The system 202 can be an online store or a content server for example. In some embodiments, the system 202 can be a content delivery system 106 as shown in FIG. 1, and the campaign 204 can include a campaign of content from content providers such as providers 109 and/or 110 shown in FIG. 1. In other embodiments, the system 202 can be a client device, such as a user terminal 102 shown in FIG. 1, and the campaign can be a campaign of content from a content delivery system 106 as shown in FIG. 1.

The system 202 can detect or receive events 206A-C associated with a campaign of content 204. The events 206A-C can include, for example, impressions, presentations, view events, gesture events, and so forth. In some cases, the system 202 can maintain a list or database or record of the events 206A-C. The system 202 can also maintain additional information associated with the events 206A-C, such as respective timestamps, identifiers, profiles, metadata, user associations, device associations, content associations, etc. For example, the system 202 can maintain a record of what content was presented during the events 206A-C, what time or date such content was presented, what application or interface was used to present the content, what device was the content presented to, what campaign the content is associated with, what publisher or advertiser the content is associated with, which publisher presented the content, etc.

The system 202 can also detect or receive a conversion 208 and maintain a record of the conversion 208. For example, the system 202 can maintain a record indicating that a specific conversion took place at a specific time and/or in response to a particular presentation of content. To this end, the system 202 can maintain various details about the conversion 208. For example, the system 202 can maintain a timestamp of the conversion 208, an identifier of the conversion 208, an association with an application or publisher, a description or type of conversion, events associated with the conversion, interactions associated with the conversion, etc. The conversion 208 can refer to a purchase from a user, a subscription, a registration, an agreement, a submission of a form or request, etc. For example, the conversion 208 can refer to a purchase by a user of an item presented in an advertisement at a device associated with the user. In this example, the system 202 can record the timestamp of the purchase, a unique identifier of the purchase, and any other metadata of the purchase, such as the item purchased, the publisher of the advertiser, and so forth. In some cases, the system 202 can receive or detect multiple conversions. For example, if a user makes several purchases or if usage of the device is shared among various users, where multiple users can make various purchases from the device.

The system 202 can then generate an association 210 based on the conversion 208 and one of the events 206A-C. In particular, the system 202 can analyze the conversion 208 and determine which of the events 206A-C resulted in the conversion 208. For example, the system 202 can analyze the conversion 208 and determine that event 206B was the event that triggered the conversion 208 or was otherwise responsible for the conversion 208. To this end, the association 210 can be an attribution or credit of the conversion 208 to one of the events 206A-C. This way, an interested party, such as an advertiser, can determine which event yielded the conversion 208. From this information, such interested party can determine which specific content presentation or application or publisher should be credited for getting a conversion. The interested party can thus determine which content presentation, advertisements, schemes, or applications are successful in obtaining conversions and which are not. An advertiser can consequently modify the campaign 204 based on attribution statistics, such as the association 210 and any other association identified or generated.

In some cases, the association 210 can be an attribution or credit of the conversion 208 to a specific campaign and/or multiple events 206A-C. For example, multiple events can have shared attribution. This can be the case if a user receives multiple instances of an invitational content item which are all at least partly responsible for the conversion 208. The multiple instances can be, for example, the same advertisement presented to the same user via a specific application, such as a social networking application. Here, the association 210 can attribute the conversion 208 to the social networking application that served the multiple instances of the advertisement to the user which led to the conversion 208.

In some embodiments, the system 202 can generate the association 210 by comparing a timestamp of the conversion 208 with the respective timestamps of each of the events associated with the conversion 208 (i.e., events 206A-C). Here, the system 202 can select the last event prior to the conversion 208 based on the timestamp of the conversion 208 and the event. The system 202 can determine the identity of the conversion 208 and the event 206B in the association 210 based on respective identifiers provided with each of the conversion 208 and the event 206B, for example. The respective identifiers can be unique identifiers associated with each of the items. Such unique identifiers can be determined by the system 202 based on metadata associated with each of the items. For example, the system can analyze event 206B and any metadata associated with it to determine the identity of the event. The system can also analyze the conversion 208 and any metadata associated with it to determine the identity of the conversion event.

In some cases, the system 202 can store, collect, or identify a timestamp and an identifier for all of the events 206A-C as the events take place or are otherwise detected. The system 202 can store or collect this information as a token of information for example. The system 202 can similarly store, collect, or identify a timestamp and an identifier for the conversion 208 as the conversion 208 takes place or is otherwise detected. Thus, when the conversion 208 takes place or is detected as previously described, the system 202 can, in some cases, associate the conversion 208 with the last event from the campaign 204 that is stored, collected, or identified prior to the conversion 208. The system 202 can then send the association 210 to another device, such as a remote server or an advertiser, to report the association 210.

Alternatively, in other embodiments, the system 202 can generate a token of information each time any of the events 206A-C takes place. Here, the token of information can include a respective timestamp and an identifier, such as a unique ID. The system 202 can then transmit the token of information to a server that is configured to manage or process conversions for the campaign 204, such as an online store. The system 202 can, for example, transmit the token as it generates the token or as the events 206A-C take place. The server can be configured to detect when a conversion takes place and automatically associate the detected conversion with the latest event in the campaign 204 based on the token received from the system 202. The server can then report or send the association 210 to another entity or device, such as an advertiser or the system 202 itself.

In some cases, the system 202 can be a client device configured to identify events for a campaign 204 and generate tokens for each detected event providing timestamp and identifying information for that event. Thus, when the system 202 performs the conversion 208, it can associate the conversion 208 with the latest event detected based on the respective token. The system 202 can also be configured to report the association to a server, such as an online store, a statistics server, or an advertiser.

As one of ordinary skill in the art will readily recognize, the system 202 can be a server configured to track the events 206A-C, the conversion 210, and any respective tokens or metadata; and collect or report associations and relevant statistics. For example, the system 202 can be a content delivery system 106 as shown in FIG. 1, a user terminal 102 as shown in FIG. 1, or a content provider 109, 110.

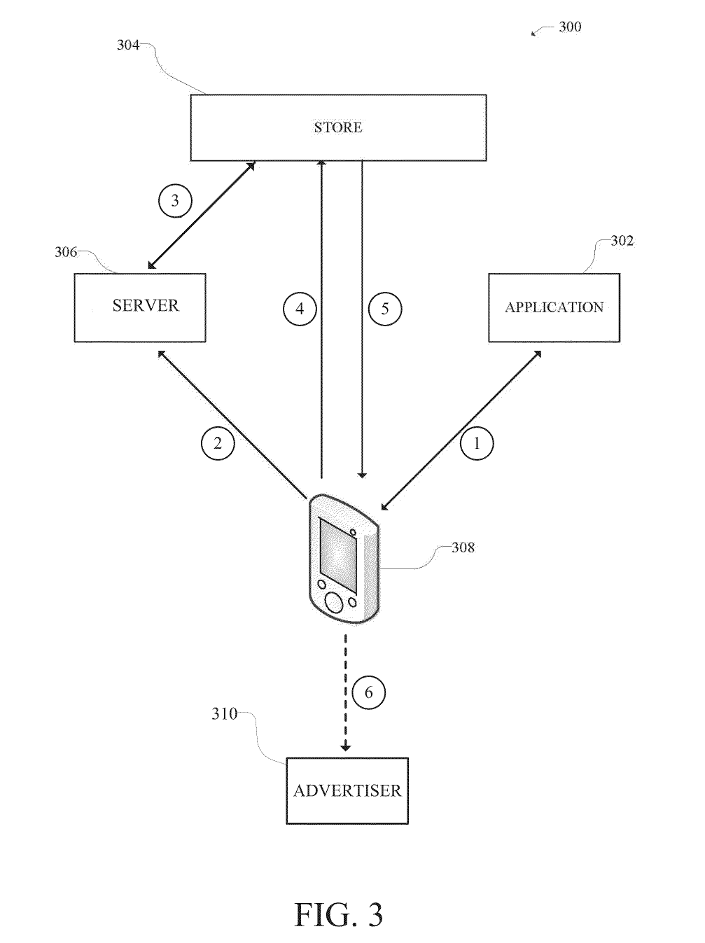

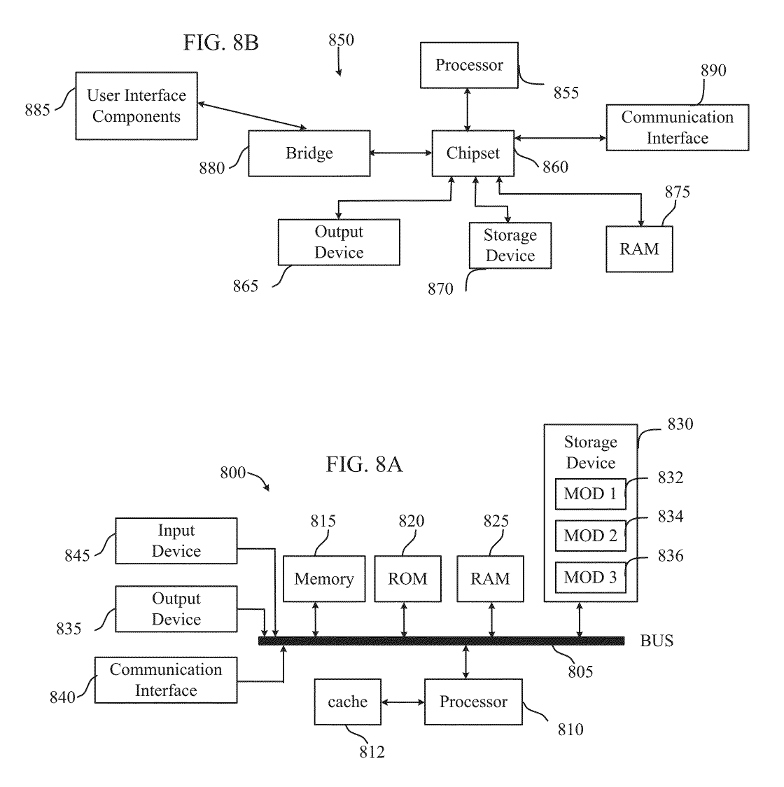

FIG. 3 illustrates a schematic diagram 300 of an exemplary configuration for content attribution. The device 308 can receive a presentation of content provided via an application 302. The device 308 can be, for example, a user terminal 102 as shown in FIG. 1 or a computing device 800 as shown in FIGS. 8A and 8B. The presentation of content can be, for example, an advertisement, an impression, or a presentation of invitational content. Moreover, the application 302 can be an application or application content accessed via the device 308. For example, the application 302 can be application content hosted on a separate device and accessed by a user on the device 308 via an application at the device 308, such as a web browser. However, in some embodiments, the application 302 can actually be an application on the device 308. Here, the application 302 can be an application launched or running on the device 308 used to present the content on the device 308. For example, the application 302 can be an application running on the device 308 and presenting an advertisement via a portion of the interface on the device 308.

The device 308 can collect, store, or report the presentation of content from the application 302. The device 308 can report the presentation of content to the server 306. The server 306 can be a content server, such as content delivery system 106 shown in FIG. 1. In some cases, the device 308 can report the content that was presented at the device 308, the timestamp of the presentation, campaign information, the application 302 used to present the content, and any other metadata to the server 306. Moreover, the server 306 or the device 308 can automatically generate a token identifying an impression that took place at the device 308, an associated timestamp, and the application 302 used for the impression. The server 306 can then forward or report the token (and any additional information) to the online store 304. The online store 304 can store or maintain the token and use the token in attributing purchases to a corresponding presentation or otherwise to report statistics associated with the presentations and purchases of content.

In some embodiments, after receiving the presentation of content from the application 302, the device 308 can communicate with the online store 304 to download or make a purchase of an item associated with the presentation of content. For example, if the presentation of content is an advertisement for gaming app A, the device 308 can communicate with the online store 304 to purchase or download the gaming app A based on the advertisement. Here, the advertisement can contain a link or reference to the online store 304 and the gaming app A within the online store 304. Thus, the device 308 can determine the necessary information to download or purchase the gaming app A from the online store 304 based on the advertisement.

Moreover, when the device 308 makes a purchase at the online store 304, the online store 304 can review the purchase, the token, and any additional information to determine if there should be an attribution of the purchase to the impression from the application 302. The online store 304 then sends the token to the mobile device 308.

The mobile device 308 can expose the token to the application that was purchased at the online store 304. For example, the mobile device 308 can provide the token to the purchased application via an API. When the device 308 then launches or executes the purchased application, the purchased application can access the attribution data. The purchased application can use or manipulate the attribution data in any way. For example, the purchased application can change its onscreen appearance or forward the attribution data to the advertiser 310.

This attribution approach can provide fine-grained reporting capabilities, while protecting the user's privacy. For example, the attribution data can be stored, kept, and maintained by the application on the mobile device itself, and in some cases, may not be directly provided to the servers in aggregate form.

In some embodiments, when communicating with the online store 304 to make the purchase or download the item associated with the presentation of content, the device 308 can transmit a token to the online store 304 to notify, or report to, the online store 304 that the device 308 has received the presentation of content from the application 302. The token can include the timestamp of the presentation of content, the identifier of the presentation, the identifier of the device 308, the identifier of the application 302, a description of the presentation of content, metadata, and so forth. Using the token, the online store 304 can then match or associate the presentation of content with the purchase or download of the item. The presentation of content here can be associated with, or related to, the item downloaded or purchased, such as an advertisement of that item as previously described.

By matching or associating the presentation of content with the purchase or download of the item, the online store 304 can attribute or credit the conversion of the item to the presentation of content by the application 302. This way, the online store 304 can determine which presentation of content and which application triggered, yielded, invited, or resulted in the conversion or is otherwise responsible for the conversion. The online store 304 can select or identify the presentation of content from multiple other presentations prior to the presentation resulting in the conversion. In other words, if multiple presentations were provided for the item without a conversion, the online store 304 can determine which of the multiple presentations actually triggered, yielded, invited, or resulted in the conversion or should otherwise be attributed to, or credited for, the conversion. The online store 304 can select or identify the specific presentation from multiple presentations based on respective timestamps or otherwise select or identify the last presentation leading to the conversion.

In some cases, the online store 304 can then report the attribution of content to the advertiser 310 or any other entity/system. In other cases, the online store 304 can report the attribution of content to the mobile device 308, which can then optionally report the attribution to the advertiser 310. Based on the attribution, the advertiser 310 can determine which application and which presentation of content resulted in the conversion and which has not. The advertiser 310 can thus maintain accurate statistics of performance of presentations and applications or publishers used for such presentations. The advertiser 310 can also tweak an on-going campaign based on such performance statistics to obtain better results or better target the presentations.

In some configurations, when the device 308 downloads or purchases the item from the online store 304, the online store 304 can generate a timestamp and an identifier of the conversion (i.e., the download or purchase) without having otherwise received a token from the device 308 or the server 306. In other words, the online store 304 itself can generate the token of information in addition to, or as opposed to, receiving the token from another entity. The online store 304 can then use the token to match or associate the specific conversion processed with the presentation of content. The online store 304 can then send the match or association to the mobile device 308 and/or the advertiser 310, attributing the conversion to the presentation and crediting the application 302, as explained above.

While the online store 304 and the server 306 are illustrated in FIG. 3 as separate entities or devices, other configurations are also contemplated herein. For example, in some embodiments, the online store 304 and the server 306 can refer to the same entity or device. One of ordinary skill in the art will readily recognize other possible implementations.

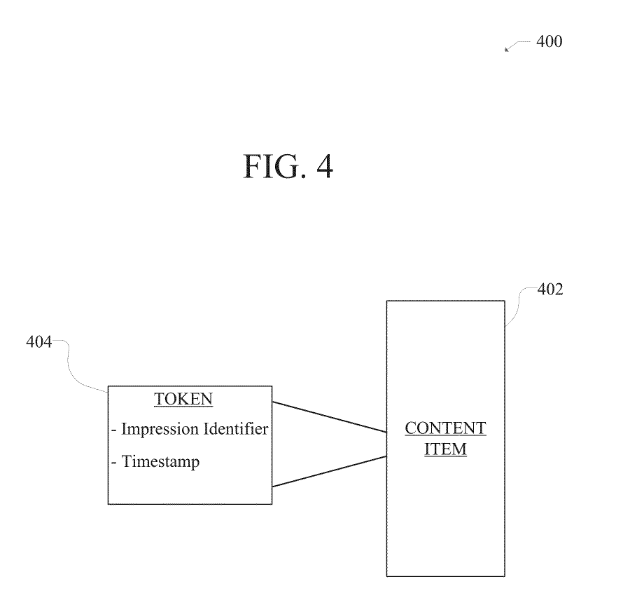

FIG. 4 illustrates an exemplary token 400 associated with a content item 402. The content item 402 can be a conversion item, such as a purchased or downloaded item. For example, the content item 402 can be an application purchased by a user from an online store. The content item 402 can have an embedded or associated token 400, which can be included with the content item 402 at the time of download or purchase, for example.

The token 400 can include a unique identifier of an impression or presentation associated with the content item 402. For example, if the content item 402 was purchase by a user in response to a presentation of advertisement X at the user's device, the token 400 can include a unique identifier of advertisement X. In other words, the token 400 can include the identifier of the impression or presentation credited for the conversion of the content item 402. The token 400 can also include a unique identifier of the campaign of content. In addition, the token 400 can include a timestamp corresponding to the impression or presentation identified by the unique identifier. For example, the token 400 can include the timestamp indicating when the impression leading to the conversion of the content item 402 was provided to the user's device.

In some configurations, the token 400 can include additional information, such as a description of the campaign or the presentation of content, an identifier of an application or interface used to present the invitational content leading to the conversion of the content item 402, the timestamp of the conversion of the content item 402, an identifier of the content item 402, or any other metadata.

The token 400 can be generated by a user's device, but can also be generated by an online store or server processing the conversion associated with the content item 402. In some cases, the token 400 is generated by the online store and transmitted to the user's device along with the content item 402 downloaded or purchased by the user via the user's device. Here, the client device can then maintain the token 400 on local storage and/or forward the token 400 to another device, such as a remote server. In other cases, the client device generates the token 400 and transmits it to the online store at the time it requests the purchase or download of the content item 402. The online store can then receive the token 400 and associate it with the purchase or download of the content item 402 to obtain an association of an event and a conversion, or otherwise to attribute the conversion to the specific impression leading to the conversion. The online store can maintain the association for statistics and logging purposes, or it can transmit the association to a remote server, such as a content server or an advertiser's server.

In some cases, the token 400 can be embedded into the content item 402 and transmitted to the client device as part of the content item 402. However, as one of ordinary skill in the art will readily recognize, the token 400 can also be a separate file from the content item 402 or can be associated with the content item 402 in various ways. Indeed, the token 400 can be a notification transmitted to report the information inside the token 400 and otherwise associated with the content item 402, for example through a link or a mapping reference in the token 400, the content item 402, or a separate file.

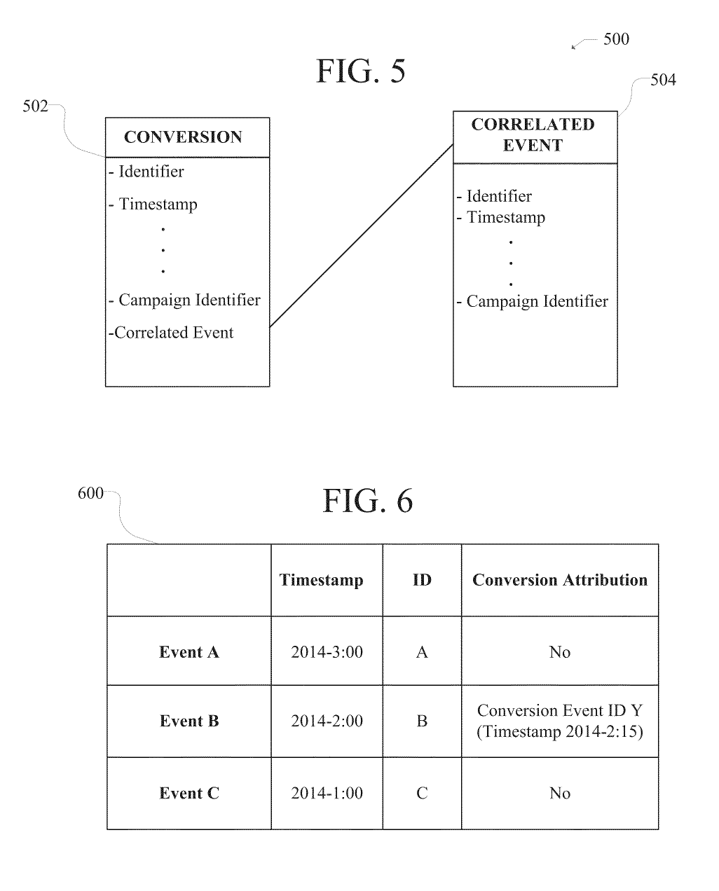

FIG. 5 illustrates an exemplary attribution mapping 500. The attribution mapping 500 can include a conversion record 502 which can include information about a previous or current conversion of an item. The information can include an identifier of the conversion, a timestamp, a campaign identifier, and a reference to a correlated or attributed event (e.g., an identifier of an event credited for the conversion in the conversion record 502). However, as one of ordinary skill in the art will readily recognize, the conversion record 502 can include any other information, such as relevant statistics, settings, preferences, links, metadata, etc.

The correlated or attributed event in the conversion record 502 can point, refer, or link to the correlated event record 504. The correlated event record 504 can also include information about a corresponding event associated with the conversion in the conversion record 502. The corresponding event here can include an impression, an advertisement, a presentation of invitational content, or any other presentation of content. Moreover, the information contained in the correlated event record 504 can include an identifier of the event, a timestamp indicating the time of event, a campaign identifier, and any other information such as an event description or metadata, for example.

In some configurations, the conversion record 502 and the correlated event record 504 can be records in a table or a database. Moreover, the conversion record 502 and the correlated event record 504 can be related in a database based on their respective identifiers and the correlated event information in the conversion record 502. For example, in a relational database, the event identifier in the correlated event record 504 can serve as the primary key of the correlated event record 504 and a secondary key in the conversion record 502. This way, both records can be uniquely related, associated, or linked to each other. This relationship can indicate an association which represents the attribution of a conversion to an event, for example.

In some cases, the conversion record 502 and the correlated event record 504 can be separate files on a storage device, records on a server or management application, objects, logs, etc.

FIG. 6 illustrates an exemplary attribution table 600. The attribution table 600 can collect, store, or maintain information about specific events that take place during a campaign of content and any attributions credited to those specific events based on other conversions that have taken place as part of the campaign. To this end, the attribution table 600 can maintain a record of each event, an associated timestamp for each event, an associated identifier, and an indication of whether a conversion has been attributed to each event. If a conversion has been attributed to an event, the attribution table 600 can specify the identity of the conversion attributed to the event and any other additional, relevant information, such as the timestamp of the conversion. For example, the attribution table 600 can include an indication specifying that conversion event Y has been attributed to event B. The attribution table 600 can include the timestamp of the conversion event Y and any other information, as previously indicated.

Events A-C in the attribution table 600 can, in some case, relate to the same campaign of content. Here, events A and C can refer to impressions or other events related to the conversion Y which did not otherwise result in the conversion Y or receive credit or attribution for the conversion Y. On the other hand, event B can refer to the event that did result or lead to the conversion Y and was thus credited for that conversion. In some cases, the determination of which of events A-C should be credited or should receive attribution for the conversion Y can be performed by comparing the respective timestamps of the events A-C. In some configurations, the event that receives credit or attribution for the conversion Y (or otherwise is associated with conversion Y) can be the event having the timestamp closest in time prior to the timestamp of conversion Y. For example, if event A has a timestamp of 3 P.M., event B has a timestamp of 2 P.M., and event C has a timestamp of 1 P.M., and the conversion Y has a timestamp of 2:15 P.M., then event B can be selected or identified to receive credit or attribution for conversion Y since it was the event closest in time prior to the conversion Y. In other words, events A and C can be identified as events taking place that are relevant to conversion Y, and event B can be identified as the event that led to the conversion Y, as it was the last event relevant to conversion Y that was presented to the user before the user initiated the conversion Y.

The attribution table 600 can provide an exemplary picture of the performance and attributions of the various events in a campaign. This can help an advertiser or content system determine which events can be optimized, or how the campaign as a whole can be optimized.

As one of ordinary skill in the art will readily recognize, the attribution table 600 contains non-limiting examples of formats and information used in analyzing events and attributions. These non-limiting examples are provided for illustration purposes and can vary in other embodiments. Indeed, other formats and types of information are contemplated herein.

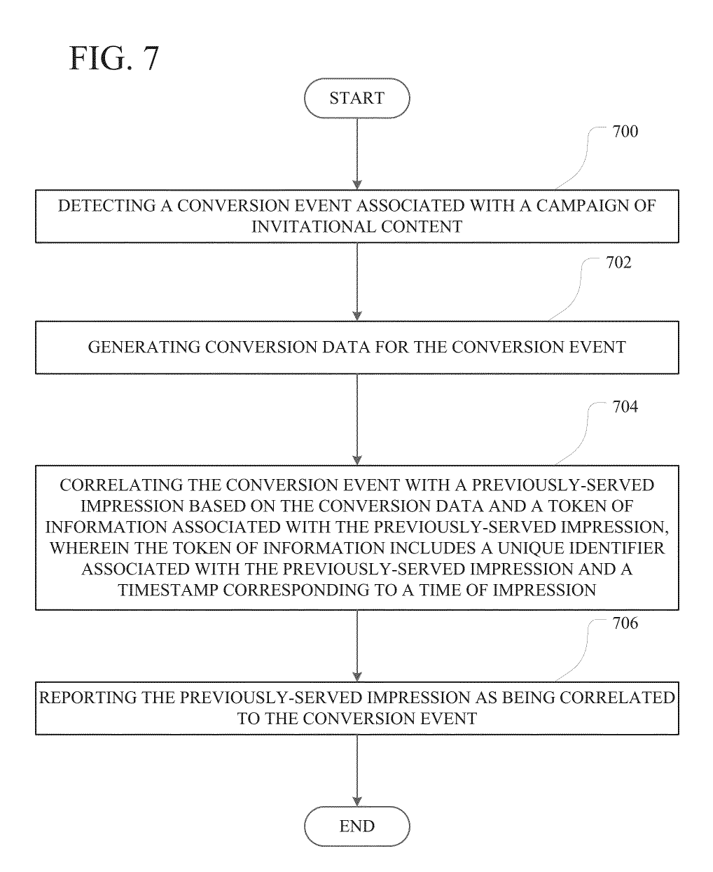

Having disclosed some basic system components and concepts, the disclosure now turns to the exemplary method embodiment shown in FIG. 7. For the sake of clarity, the method is described in terms of a content delivery system 106, as shown in FIG. 1, configured to practice the method. The steps outlined herein are exemplary and can be implemented in any combination thereof, including combinations that exclude, add, or modify certain steps.

A content delivery system 106 first detects a conversion event associated with a campaign of invitational content (700). The conversion event can be, for example, an action taken by a user to purchase or download an item, initiate a subscription, submit a registration, etc. In some cases, the campaign of invitational content can be an advertising or subscription campaign. Here, the conversion event associated with the campaign of invitational content can be a purchase of an item advertised via an advertising campaign, for example.

The content delivery system 106 then generates conversion data for the conversion event (702). Here, the conversion data can include a timestamp, a conversion description or identifier, user information, campaign information, a history of impressions, a previous impression, triggering details, and so forth. In some aspects, the content delivery system 106 generates the conversion data and associates it with the conversion event. For example, the content delivery system 106 can generate a record describing the conversion event and associate it with a timestamp or any other relevant metadata. The conversion data can thus include an association of conversion details or metadata and information about the conversion event or otherwise associated with the conversion event. The content delivery system 106 can store the conversion data, including any associations made with information relating to the conversion event, in a local or remote store, database, server, etc. For example, the content delivery system 106 can maintain a database of conversion events and store any conversion data generated in the database of conversion events.

Next, the content delivery system 106 correlates the conversion event with a previously-served impression based on the conversion data and a token of information associated with the previously-served impression, wherein the token of information includes a unique identifier associated with the previously-served impression and a timestamp corresponding to a time of impression (704). In some cases, the content delivery system 106 can instead correlate the conversion event to multiple impressions served to a user which contributed or led to the conversion event. In yet other cases, the content delivery system 106 can correlate the conversion event to an application or environment having served one or more impressions that led to the conversion.

The content delivery system 106 can compare the timestamp of the conversion event with the timestamp of the previously-served impression and any other timestamps associated with other impressions, in order to identify the specific impression that should be correlated to the conversion event. Each impression in a campaign can include the token previously described. Thus, based on the unique identifier in each impression's token, the content delivery system 106 can identify specific impressions corresponding to timestamps that the content delivery system 106 has compared with the timestamp of the conversion event to make a correlation.

The content delivery system 106 can correlate the conversion event with the previously-served impression as part of identifying which impression triggered the conversion event, is responsible for the conversion event, or should receive credit or attribution for the conversion event. Moreover, in some aspects, the impression correlated with the conversion event is the last impression leading to the conversion event. For example, if an item of invitational content has several impressions and is associated with a conversion event, the impression correlated to the conversion event can be the last of the several impressions prior to the correlation event. To this end, the content delivery system 106 can identify such last impression by comparing the timestamps of impressions and conversion events, as previously described. Further, in some embodiments, the previously-served impression can refer to the last impression before the conversion event.

Once the content delivery system 106 has correlated the previously-served impression with the conversion event, it can report the previously-served impression as being correlated to the conversion event (706). The content delivery system 106 can report the correlation to a server, a content provider, an advertiser, a developer, a user, a statistics collection device, etc. When reporting the correlation, the content delivery system 106 can attribute the conversion event to the previously-served impression. Thus, the content delivery system 106 can credit the previously-served impression, and the application having served the invitational content associated with the previously-served impression, for the conversion event, as triggering or obtaining the conversion event. This way, an advertiser, for example, can which specific impressions have resulted in a conversion event, and identify which applications or publishers have yielded conversions. The advertiser can also compare conversion results between applications, publishers, and impressions to determine which have been successful and which have not.

FIG. 8A, and FIG. 8B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 8A illustrates a conventional system bus computing system architecture 800 wherein the components of the system are in electrical communication with each other using a bus 805. Exemplary system 800 includes a processing unit (CPU or processor) 810 and a system bus 805 that couples various system components including the system memory 815, such as read only memory (ROM) 820 and random access memory (RAM) 825, to the processor 810. The system 800 can include a cache of high-speed memory connected directly with, in close proximity to, or integrated as part of the processor 810. The system 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other system memory 815 may be available for use as well. The memory 815 can include multiple different types of memory with different performance characteristics. The processor 810 can include any general purpose processor and a hardware module or software module, such as module 1 832, module 2 834, and module 3 836 stored in storage device 830, configured to control the processor 810 as well as a special-purpose processor where software instructions are incorporated into the actual processor design. The processor 810 may essentially be a completely self-contained computing system, containing multiple cores or processors, a bus, memory controller, cache, etc. A multi-core processor may be symmetric or asymmetric.

To enable user interaction with the computing device 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art. In some instances, multimodal systems can enable a user to provide multiple types of input to communicate with the computing device 800. The communications interface 840 can generally govern and manage the user input and system output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof.

The storage device 830 can include software modules 832, 834, 836 for controlling the processor 810. Other hardware or software modules are contemplated. The storage device 830 can be connected to the system bus 805. In one aspect, a hardware module that performs a particular function can include the software component stored in a computer-readable medium in connection with the necessary hardware components, such as the processor 810, bus 805, display 835, and so forth, to carry out the function.

FIG. 8B illustrates a computer system 850 having a chipset architecture that can be used in executing the described method and generating and displaying a graphical user interface (GUI). Computer system 850 is an example of computer hardware, software, and firmware that can be used to implement the disclosed technology. System 850 can include a processor 855, representative of any number of physically and/or logically distinct resources capable of executing software, firmware, and hardware configured to perform identified computations. Processor 855 can communicate with a chipset 860 that can control input to and output from processor 855. In this example, chipset 860 outputs information to output 865, such as a display, and can read and write information to storage device 870, which can include magnetic media, and solid state media, for example. Chipset 860 can also read data from and write data to RAM 675. A bridge 880 for interfacing with a variety of user interface components 885 can be provided for interfacing with chipset 860. Such user interface components 885 can include a keyboard, a microphone, touch detection and processing circuitry, a pointing device, such as a mouse, and so on. In general, inputs to system 850 can come from any of a variety of sources, machine generated and/or human generated.

Chipset 860 can also interface with one or more communication interfaces 890 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 855 analyzing data stored in storage 870 or 875. Further, the machine can receive inputs from a user via user interface components 885 and execute appropriate functions, such as browsing functions by interpreting these inputs using processor 855.

It can be appreciated that exemplary systems 800 and 850 can have more than one processor 810 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Claim language reciting “at least one of” a set indicates that one member of the set or multiple members of the set satisfy the claim. Tangible computer-readable storage media, computer-readable storage devices, or computer-readable memory devices, expressly exclude media such as transitory waves, energy, carrier signals, electromagnetic waves, and signals per se.

We claim:

1. A computer-implemented method comprising:
detecting a conversion event associated with a campaign of invitational content;
correlating the conversion event with at least one previously-served impression based on information associated with the at least one previously-served impression, wherein the information comprises a timestamp corresponding to a time of impression and an identifier associated with at least one of the previously-served impression or the campaign; and
reporting the at least one previously-served impression as being correlated to the conversion event.

2. The computer-implemented method of claim 1, wherein the information comprises a token of information generated when the previously-served impression is served, the method further comprising:
attributing the conversion event to the at least one previously-served impression based on a correlation of the conversion event with the at least one previously-served impression; and
modifying the campaign based on at least one of the attributing and the correlation.

3. The computer-implemented method of claim 1, wherein the information comprises a token of information, the method further comprising:
generating the token of information by determining the time of impression and the identifier, wherein the generating of the token is triggered by a detection of the previously-served impression;
storing the token of information after the previously-served impression is served to a user device associated with the conversion event; and
associating the token with at least one of the conversion event or a content item associated with the conversion event.

4. The computer-implemented method of claim 1, wherein the conversion event is correlated with the previously-served impression based on conversion data associated with the conversion event, the conversion data comprising a conversion timestamp, and wherein correlating the conversion event with the previously-served impression comprises comparing the conversion timestamp with the timestamp associated with the previously-served impression.

5. The computer-implemented method of claim 4, wherein the previously-served impression comprises an impression triggering the conversion event, and wherein the previously-served impression is identified as the impression triggering the conversion event from a plurality of impressions associated with the campaign of invitational content.

6. The computer-implemented method of claim 1, wherein the previously-served impression is associated with the campaign of invitational content, and wherein the time of impression is before a first time corresponding to the conversion event and after a second time corresponding to a different impression associated with the campaign of invitational content.

7. The computer-implemented method of claim 6, wherein the previously-served impression is configured to perform at least one of: trigger the conversion event, receive a request from a user to initiate the conversion event, present a link associated with the conversion event, and perform an action associated with the conversion event.

8. The computer-implemented method of claim 1, wherein the conversion event comprises a user action associated with the campaign of invitational content, the user action comprising at least one of a purchase, a user transaction, or a download of an item associated with the campaign of invitational content.

9. The computer-implemented method of claim 1, further comprising:
in response to a request to download an item associated with the conversion event, sending the item and a token comprising the information to a user device; and
correlating the conversion event with the previously-served impression based on the token of information in the download.

10. The computer-implemented method of claim 1, further comprising:
recording a plurality of tokens of information associated with a plurality of impressions; and
comparing the plurality of tokens of information with each other to identify a last-served impression prior to the conversion event; and
correlating the conversion event with the last-served impression.

11. The computer-implemented method of claim 1, further comprising:
recording the token of information when the previously-served impression is served; and
in response to a request to download an item associated with the conversion event, sending the item and the token of information to a requesting device.

12. The computer-implemented method of claim 1, wherein the conversion event comprises a download of an application, and wherein the download includes the token of information.

13. The computer-implemented method of claim 1, wherein the conversion event is associated with a conversion timestamp, and wherein correlating the conversion event with the previously-served impression comprises associating the conversion timestamp with the timestamp in the token of information to yield an association and attributing the conversion event to the previously-served impression based on the association.

14. The computer-implemented method of claim 1, further comprising attributing the conversion event to a plurality of impressions based on conversion-to-impression correlations, wherein the conversion event is associated with a conversion timestamp, and wherein attributing the conversion event to the plurality of impressions comprises comparing the conversion timestamp with a plurality of timestamps corresponding to served impressions associated with the campaign, and selecting the plurality of impressions.

15. The computer-implemented method of claim 1, wherein the information comprises a token having an indication of the timestamp and the identifier, the method further comprising receiving the token from a client device after the at least one previously-served impression is presented at the client device.

16. The computer-implemented method of claim 1, wherein correlating the conversion event with the previously-served impression comprises detecting a plurality of user events corresponding to at least one impression, identifying a last one of the user events prior to the conversion event, and correlating the conversion event with an impression associated with the last one of the user events, wherein the user events comprise at least one of a view event, a gesture, a click, or a download request.

17. The computer-implemented method of claim 1, wherein the conversion event comprises a request to download an item from an online store, wherein the online store stores a token comprising the information for download with the item from the online store.

18. A system comprising:
a processor; and
a computer-readable storage medium having stored therein instructions which, when executed by the processor, cause the processor to perform operations comprising:
detecting a conversion event associated with a campaign of invitational content;
identifying an impression served prior to the conversion event from a plurality of impressions associated with the campaign of invitational content, wherein the impression is identified by comparing a conversion timestamp associated with the conversion event with respective timestamps associated with each of the plurality of impressions; and
associating the impression with the conversion event to yield an association.

19. The system of claim 18, storing additional instructions which, when executed by the processor, result in an operation further comprising, based on the association, attributing the conversion event to the impression to yield a conversion attribution.

20. The system of claim 19, storing additional instructions which, when executed by the processor, result in an operation further comprising reporting the conversion attribution to a device associated with the campaign of invitational content.

21. The system of claim 18, wherein the conversion event comprises a download of an application, and wherein a timestamp associated with the impression is included in the download of the application.

22. A non-transitory computer-readable storage medium having stored therein instructions which, when executed by a processor, cause the processor to perform operations comprising:
receiving a request to download an item at an online store;
storing a first timestamp associated with the request and a second timestamp associated with a presentation of invitational content prior to the request, the presentation of invitational content being associated with the item at the online store;
sending the item and the second timestamp to a client device associated with the request, wherein the second timestamp is sent in a token comprising the second timestamp and a unique identifier associated with the presentation of invitational content, the token being bundled with the item for use in correlating the request to download the item with the presentation of invitational content.

23. The non-transitory computer-readable storage medium of claim 22, wherein the item comprises an application, and wherein the request is received from a client device associated with a user requesting the download.

24. The non-transitory computer-readable storage medium of claim 23, wherein the presentation of invitational content comprises an impression at the client device, and wherein the second timestamp is received and stored at the online store from the client device after the impression at the client device.

25. The non-transitory computer-readable storage medium of claim 22, storing additional instructions which, when executed by the processor, result in operations further comprising:
correlating the request to download with the presentation of invitational content based on at least one of the first timestamp and the second timestamp; and
sending a notification to a remote device indicating that a download of the item by a user is attributed to the presentation of invitational content.
